(19) United States
(12) Patent Application Publication
(10) Pub. No.: US 2018/0129400 A1
(43) Pub. Date: May 10, 2018

(54) Method And Device For Media Content-Based Interaction And Medium

(71) Applicant: Tencent Technology (Shenzhen) Company Limited, Shenzhen (CN)

(72) Inventors: Hongcheng FU, Shenzhen (CN); Zhu LIANG, Shenzhen (CN); Guojin ZHOU, Shenzhen (CN)

(73) Assignee: Tencent Technology (Shenzhen) Company Limited, Shenzhen (CN)

(21) Appl. No.: 15/864,616

(22) Filed: Jan. 8, 2018

Related U.S. Application Data
(63) Continuation of application No. PCT/CN2016/082300, filed on May 17, 2016.

(30) Foreign Application Priority Data
Aug. 3, 2015 (CN) 201510482411.3

(51) Int. Cl. G06F 3/0484; G06F 3/0483; G06F 17/30

(52) U.S. Cl. CPC G06F 3/04842; G06F 3/0483; H04L 67/02; G06F 17/30752; G06F 17/30867

(57) ABSTRACT

Provided are a method and a device for media content-based interaction, and a computer readable medium. The method includes: receiving an acquisition operation for dynamic of a user on a media page; acquiring dynamic data of the user and dynamic data of a friend associated with the user in response to the acquisition operation for dynamic, where the dynamic data includes marking on a piece of media content and interaction information associated with the marked media content; and displaying on a display page for dynamic based on the dynamic data of the user and the dynamic data of the friend.

The present application is a continuation of International Patent Application No. PCT/CN2016/082300, filed on May 17, 2016, which claims the priority to Chinese Patent Application No. 201510482411.3, titled “METHOD AND SYSTEM FOR MEDIA CONTENT-BASED INTERACTION”, filed with the Chinese State Intellectual Property Office on Aug. 3, 2015, both of which are incorporated herein by reference in their entireties.

### FIELD

The disclosure relates to the internet application technology, and particularly to a method and a device for media content-based interaction.

### BACKGROUND

With the development of the internet application, more and more users perform operations on media content via the internet applications to enrich their work and life. For example, a user may choose his favorite music via a corresponding music client or a music website in the browser in order to listen to music resource in the internet.

In the music client or music website which the user logs in, the favorite music may be marked as favorite by an particular operation, and the music marked as favorite by the user is recorded in a background server, thus, the user only need to log in the music client or the music website to obtain his favorite music without repeated choosing.

However, in the process of the user obtaining the music resource, the user only marks favorite music independently according to the favor. For the music client or the music website that provides the music resource, various kinds of information is provided based on the mainline of the single music, therefore the information the user focuses on may not be provided accurately in the process of the user obtaining the music.

### SUMMARY

The disclosure provides a method for media content-based interaction in which a marking behavior of other users to a media content may be acquired to provide information which a user focuses on accurately, to solve a problem of displaying various useless information to the user based on a mainline of single media content in conventional art.

Furthermore, it is necessary to provide a device for media content-based interaction in which a marking behavior of other users to a media content may be acquired to provide information which a user focuses on accurately.

A method for media content-based interaction includes:

receiving an acquisition operation for dynamic triggered by a user on a media page;

acquiring dynamic data of the user and dynamic data of a friend in response to the acquisition operation for dynamic;

displaying a dynamic of marking the media content by the user and the friend associated with the user on a display page for dynamic according to the acquired dynamic data of the user and the dynamic data of the friend, and adding interaction information to the corresponding dynamic.

A device for media content-based interaction includes:

a dynamic receiving module, configured to receive an acquisition operation for dynamic triggered by a user on a media page;

a dynamic acquiring module, configured to acquire dynamic data of the user and dynamic data of a friend in response to the acquisition operation for dynamic;

a dynamic displaying module, configured to display a dynamic of marking the media content by the user and the friend associated with the user on a display page for dynamic according to the acquired dynamic data of the user and the dynamic data of the friend, and add interaction information to the corresponding dynamic.

Compared with the conventional art, the method and device for media content-based interaction of the present disclosure have the following beneficial effects. In the media page providing various media content, the dynamic of marking the media content by other user may be acquired triggering the acquisition operation for dynamic on the media page. That is, the dynamic of marking the media content by the friend of a logged-in user on the media page, and the dynamic of marking the media content by the user may be acquired. Particularly, the dynamic data of the user and the dynamic data of the friend associated with the logged-in user may be acquired from the data of marking the media content by users via the acquisition operation for dynamic. The dynamic of marking the media content by the user and the friend associated with the logged-in user is displayed on the display page for dynamic of the logged-in user based on the acquired dynamic data of the user and the acquired dynamic data of the friend, and the interaction information is added to the corresponding dynamic. The logged-in user may acquire the marking behavior on the media content by other user, i.e., the friend, thus, the generated dynamic may provide the information the logged-in user focuses on accurately.

### BRIEF DESCRIPTION OF THE DRAWINGS

FIG. 1 is a flow chart of a method for media content-based interaction according to an embodiment.

FIG. 2 is a flow chart of a method of displaying the dynamic of marking the media content by the user and the friend associated with the logged-in user on a display page for dynamic based on the acquired dynamic data of the user and the acquired dynamic data of the friend and adding the interaction information to the corresponding dynamic in FIG. 1.

FIG. 3 is a schematic diagram illustrating an interface of the display page for dynamic according to an embodiment.

FIG. 4 is a flow chart of a method for media content-based interaction according to another embodiment.

FIG. 5 is a schematic diagram illustrating an interface of comments display according to an embodiment.

FIG. 6 is a flow chart of a method for media content-based interaction according to another embodiment.

FIG. 7 is a flow chart of a method for media content-based interaction according to another embodiment.

FIG. 8 is a schematic diagram illustrating an interface of the mark ranking of “friend” and “I” in 30 days according to an embodiment.

FIG. 9 is a schematic diagram illustrating an interface of the display page for dynamic according to an embodiment.

FIG. 10 is a schematic diagram illustrating an interface of a list of the media content marked by the logged-in user according to an embodiment.

FIG. 11 is a schematic diagram of users who marks the same song as favorite according to an embodiment.

FIG. 12 is a flow chart of a method for media content-based interaction according to another embodiment.

FIG. 13 is a timing diagram of adding a song as favorite according to an embodiment.

FIG. 14 is a timing diagram of viewing the dynamic according to an embodiment.

FIG. 15 is a timing diagram of publishing comments according to an embodiment.

FIG. 16 is a schematic structure diagram of a system for media content-based interaction according to an embodiment.

FIG. 17 is a schematic structure diagram of a dynamic displaying module in FIG. 16.

FIG. 18 is a schematic structure diagram of a system for media content-based interaction according to another embodiment.

FIG. 19 is a schematic structure diagram of a system for media content-based interaction according to another embodiment.

FIG. 20 is a schematic structure diagram of a system for media content-based interaction according to another embodiment.

FIG. 21 is a schematic structure diagram of a system for media content-based interaction according to another embodiment.

FIG. 22 is a module diagram of a computer system provided in the embodiment of the present disclosure.

### DETAILED DESCRIPTION OF EMBODIMENTS

The exemplary embodiments embodying the features and advantages of the present disclosure are described in detail in the following description. It should be understood that the disclosure is capable of having various changes in various embodiments without departing from the scope of the disclosure, and the description and illustration are only for illustrating, and should not be interpreted as limiting the disclosure.

As described before, various media content, such as music, video, are the resources acquired through an application client or a website page at anywhere and anytime, furthermore, the media content may be played in freedom, and the marking behavior such as collection and marking as favorite may be triggered on favorite media content in order to obtain the media content which the user wants to play later via the collected media content or the media content marked as favorite without acquiring the media content by triggering searching and selecting operations for the media content.

The page that provides the media content is optimized in functionality, which makes it convenient to acquire the media content and simplifies the operation. However, the optimization direction is that extending mainly based on the media content, in a case where the user need to acquire the media content that the user focuses on and related information, the user still needs to execute the various operations such as searching to realize it. And the media content the user focuses on and related information are usually lost within mass media contents and other information, the information focused by the user may not be provided accurately. Particularly, in a case where the user wants to acquire the information related to the media content of other users in close relations with the user, the user has to acquire the information via additional communication with other users, which results in poor real-time capability.

In view of this, a method for media content-based interaction is provided to provide the focused information related to the media content, for example, the information related to the media content of other users in close relations may be acquired in a real time manner without additional communication, which guarantees the accuracy and the effectiveness of providing information related to the media content.

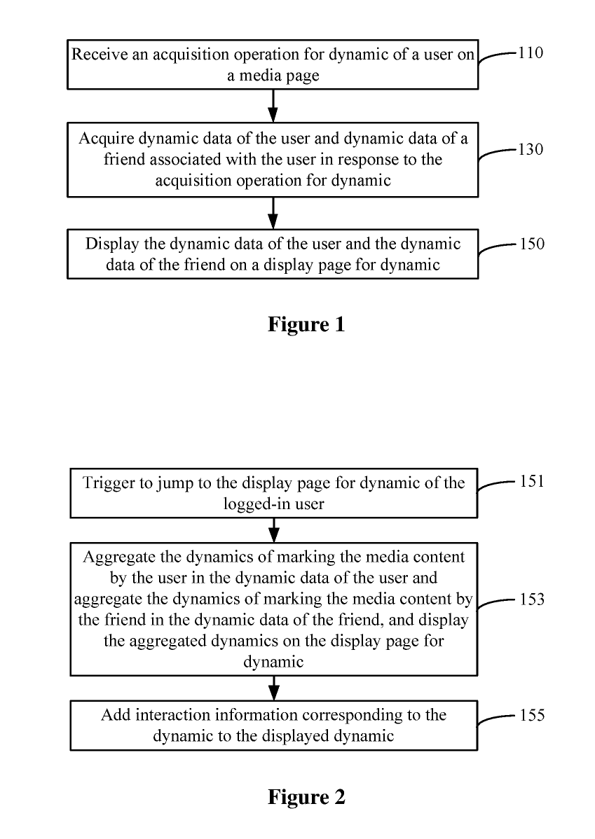

Particularly, as shown in FIG. 1, in an embodiment, a method for media content-based interaction, includes steps 110 to 150.

In step 110, an acquisition operation for dynamic triggered by a user on a media page is received. The acquisition operation for dynamic is performed to acquire data of a dynamic. For example, the dynamic includes marking on a piece of media content and interaction information associated with marked media content. In an embodiment, the acquisition operation for dynamic of the user is detected when the user touches an icon for acquiring dynamics, which is not limited herein.

The media page is any page which includes media content, such as, the page including multiple pieces of media content, the page currently playing any media content, a playing list of preselected media content. The media page is provided with a mark triggering entry corresponding to the media content, the marking on any media content on the media page may be realized by the mark triggering entry conveniently and quickly.

In a case where the media page is the page where any media content is played, there is the unique mark triggering entry corresponding to the currently played media content on the page, the marking on the currently played media content, such as, marking the currently played media content as favorite media content may be realized via clicking the mark triggering entry by a logged-in user.

The mark triggering entry may be a button configured to mark the media content on the page, each piece of media content is corresponding to a mark triggering entry in the page. For example, a button of “I like” may be set for each piece of media content on the page or a button of “I also like” may be set for the media content marked by other users.

In some embodiments, the user is the logged-in user. In this application, the logged-in user is the user who logs in the media page currently.

In a process of monitoring whether the acquisition operation for dynamic is triggered on the media page, the currently logged-in user may be acquired firstly, after the currently logged-in user of the media page is known, the triggered acquisition operation for dynamic may be responded accurately.

In step 130, dynamic data of the user and dynamic data of a friend are acquired in response to the acquisition operation for dynamic.

An operation of acquiring the dynamic data of the user and the dynamic data of the friend associated with the logged-in user is triggered by the acquisition operation for dynamic, that is, the dynamic data of the logged-in user and the dynamic data of the friend of the logged-in user are acquired.

The dynamic data of the user indicates the marking behavior triggered by the logged-in user and the interaction with the friend for the marking behavior; the dynamic data of the friend indicates the marking behavior of the friend on the media content and the interaction about the marking of the media content with a friend of the friend.

The dynamic data of the user records a dynamic of marking media content related to the logged-in user and interaction information for the dynamic. For example, the dynamic data of the user includes marking on a song by the user, and comments for the song made by friends of the user. The dynamic data of the friend records a dynamic of marking media content related to the friend of the logged-in user and the interaction information for the dynamic. For example, the dynamic data of the friend includes marking on a video by the friend, and comments for the video made by others.

For any user, any media content may be marked by the user after the user logins, the marking on the media content by the current logged-in user is recorded and updated to the data of marking the media content by users.

In step 150, the dynamic of marking the media content by the user and the friend associated with the logged-in user is displayed on a display page for dynamic based on the acquired dynamic data of the user and the acquired dynamic data of the friend and the interaction information is added to the corresponding dynamic.

As the acquisition operation for dynamic is triggered, in a period of acquiring the dynamic data of the user and the dynamic data of the friend, the page is jumped, that is, the media page jumps to the display page for dynamic.

Definitely, as described above, the media page is the any page including media content, hence, the media page may also be the display page for dynamic to mark the media content marked by the friend in the display page for dynamic. For example, the media content marked as the favorite by the friend in the display page for dynamic may be marked as the favorite by the current logged-in user as well, in this case, the acquisition operation for dynamic is a refresh operation of the page.

As described above, the data of marking the media content by users is configured to record the marking on media content by all users. For any user, data recording the marking on the media content by the user i.e., the dynamic data of the user, may be acquired from the data of marking the media content by users. Data recording the marking on the media content by the friend, i.e., the dynamic data of the friend, may also be acquired from the data of marking the media content by users.

Both the dynamic data of the user and the dynamic data of the friend include the interaction information. The interaction information is configured to record the interaction between the user and the friend, which may include: a dynamic corresponding to a marking behavior triggered by the friend on the media content marked by the user, the comments of the friend on the media content marked by the user, a reply of the user or other friend to the comments.

By this process, the interaction between the user and the friend is performed based on the mainline of the marked media content, which in turn help the user acquire quickly the media content the user is interested in or the user likes based on the media content marked by the friend on the display page for dynamic and the interaction information without searching, in this way, it is avoided that the user acquires mass useless information.

Furthermore, with the cooperation of the acquired dynamic data of the user and the acquired dynamic data of the friend, the media content is no longer displayed only based on the single mainline of the media content, the marking on media content by the user and the friend is displayed in a form of the dynamic, which enhances the interaction between the user and the friend, also provides the user and the friend with an effective assistance for selecting new media content.

Furthermore, the media content marked by the friend and the interaction of other friend about the media content are acquired via the dynamic of the marking on the media content by the friend. Therefore, for the logged-in user, the acquiring of the media content may be realized via this way, which significantly reduces the searching and selecting in the mass media content, significantly increases the accuracy of acquiring the focused information without the additional communication, and thus the real-time capability is improved significantly.

Furthermore, in the embodiment, the step 130 includes: acquiring the dynamic data of the user associated with the logged-in user via the acquisition operation for dynamic, and acquiring the dynamic data of the friend associated with the logged-in user according to the friend relationship of the logged-in user.

That is to say, after triggering the acquisition operation for dynamic, the friend relationship of the logged-in user is firstly queried, and then, it is determined which users are the friends of the logged-in user according to the queried friend relationship, and then the dynamic data of the friend is acquired.

In an embodiment, as shown in FIG. 2, the step 150 includes steps 151 to 155.

In step 151, it is triggered to jump to the display page for dynamic of the logged-in user.

In step 153, the dynamics of marking the media content by the user in the dynamic data of the user are aggregated and the dynamics of marking the media content by the friend in the dynamic data of the friend are aggregated, and the aggregated dynamics are displayed on the display page for dynamic.

In step 155, interaction information corresponding to the dynamic is added to the displayed dynamic.

Some dynamics of marking the media content by the user and the interaction information corresponding to the dynamics are acquired from the dynamic data of the user, some dynamics of marking the media content by the friend and the interaction information corresponding to the dynamics are acquired from the dynamic data of the friend.

Some dynamics of marking the media content by the user are aggregated and the interaction information in the dynamic data of the user is added to the corresponding dynamics. Correspondingly, some dynamics of marking the media content by the friend are aggregated and the interaction information in the dynamic data of the friend is added to the corresponding dynamics.

The aggregated dynamics of marking the media content by the user and the aggregated dynamics of marking the media content by the friend are displayed in different areas, for convenience of viewing.

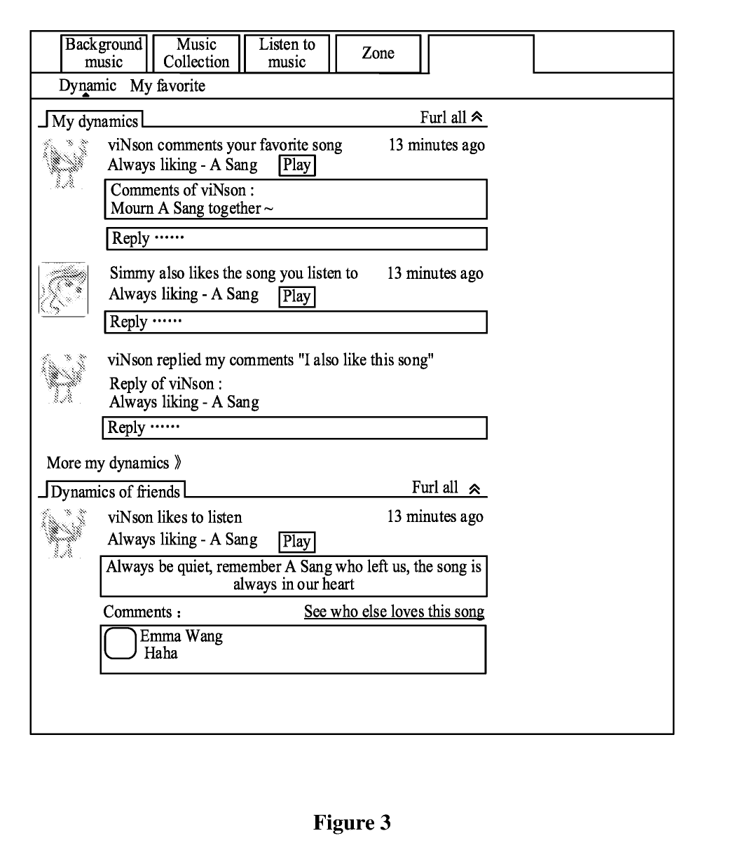

Particularly, the display page for dynamic of the logged-in user includes a display area where a “my dynamic” is located and a display area where a “dynamic of the friend” is located. The aggregated dynamics of marking the media content by the user are displayed on the display area where the “my dynamic” is located. The aggregated dynamics of marking the media content by the friend are displayed on the display area where the “dynamic of the friend” is located, the obtained display page for dynamic is shown in FIG. 3.

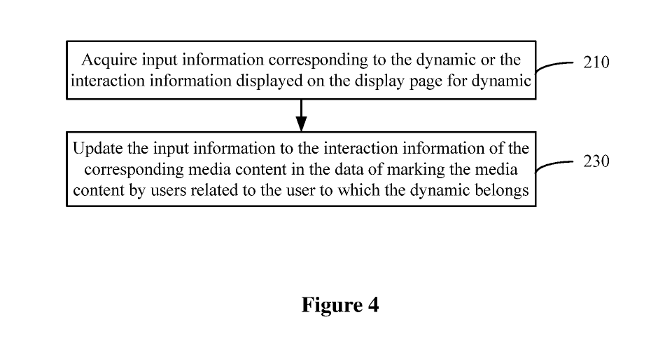

Reference is made to FIG. 4, in an embodiment, the method described above further includes steps 210 to 230.

In step 210, input information corresponding to the dynamic or the interaction information displayed on the display page for dynamic is acquired.

In a process of dynamically displaying the marking on the media content by the user and the friend on the display page for dynamic, there is an information input box corresponding to the each displayed dynamic. The information input box is configured to input information, and input information acquired through the information input box is updated to the data of marking the media content by users.

In step 230, the input information is updated to the interaction information of the corresponding media content in the data of marking the media content by users related to the user to which the dynamic belongs.

The interaction information includes the comments of the corresponding dynamic and the reply to the comments. For example, for the dynamic of marking the media content by the user, the interaction information includes the comments of the friend to the dynamic, the reply of the user to the comments, and even the reply of the other friend to the comments.

In the display page for dynamic, one information input box corresponds to only one dynamic, hence, after the input information is acquired via an information inputting operation triggered in the information input box, updating is performed according to the dynamic corresponding to the input information and the user to which the dynamic belongs, to store the acquired input information into the interaction information in the corresponding media content in the data of marking the media content by users.

By the process described above, the interaction based on the media content between the user and the friend is realized on the display page for dynamic, which makes the providing of the media content be integrated into a virtual social network and enhance the user engagement. In a case where the user and the friend need to perform interaction about the media content, there is no need for the user and the friend to switch back and forth between the page where the media content is located and the virtual social network page, which improves the convenience of the operation.

Furthermore, in the embodiment, the method described above further includes acquiring the interaction information from the dynamic data of the user and displaying the acquired interaction information in response to an interaction viewing operation triggered by the logged-in user.

For the interaction information included in the data of marking the media content by users, the logged-in user may view the comments of the friend to the logged-in user by triggering the interaction viewing operation.

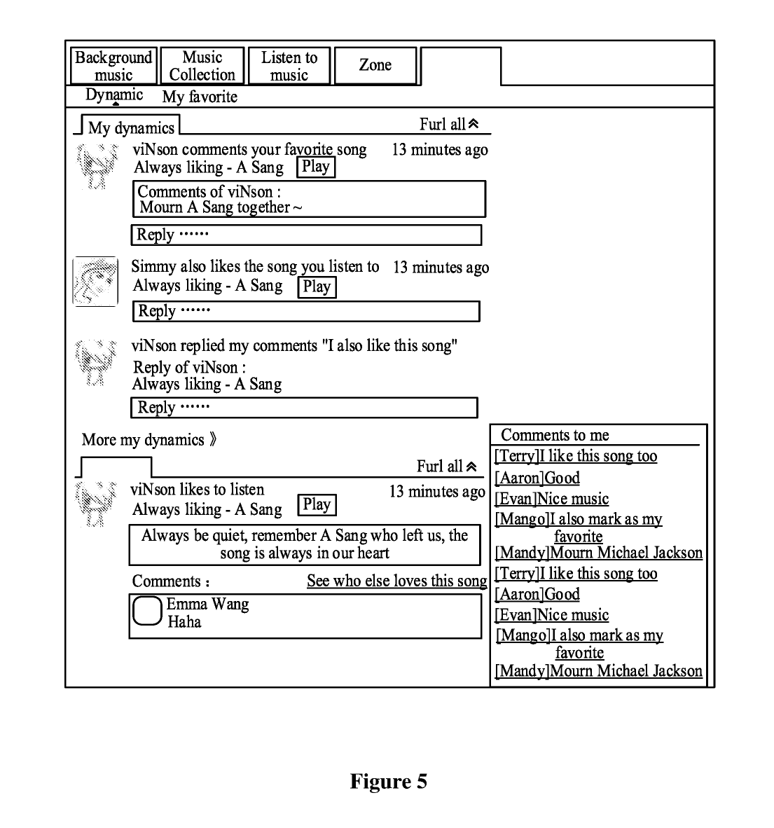

It should be noted that, the displaying of the acquired interaction information, i.e., the displaying of the comments of the friend to the logged-in user, is located in an area of the display page for dynamic, referring to FIG. 5, in this case, the interaction viewing operation is the triggered acquisition operation for dynamic on the media page.

Furthermore, in the embodiment, the display page for dynamic is a display page for dynamic logged by the friend of the logged-in user, the dynamic is a dynamic of marking the media content by the user related to the logged-in user, in this case, before the step 210 described above, the method described above further includes:

triggering an unread counter corresponding to the logged-in user to perform a self-increase operation to obtain the number of unread messages of the logged-in user and identifying and displaying the number.

That is to say, in a case where the friend publishes the comments to the dynamic corresponding to the logged-in user or reply any comments or the replies to the dynamic corresponding to the logged-in user on the media page where the friend currently logs, the unread counter corresponding to the logged-in user is triggered to perform the self-increase operation to obtain the number of unread messages of the logged-in user and the number is identified. The number of unread messages is displayed actively on the displaying page in a side where the logged-in user is located, so as to prompt to read the unread comments and/or replies.

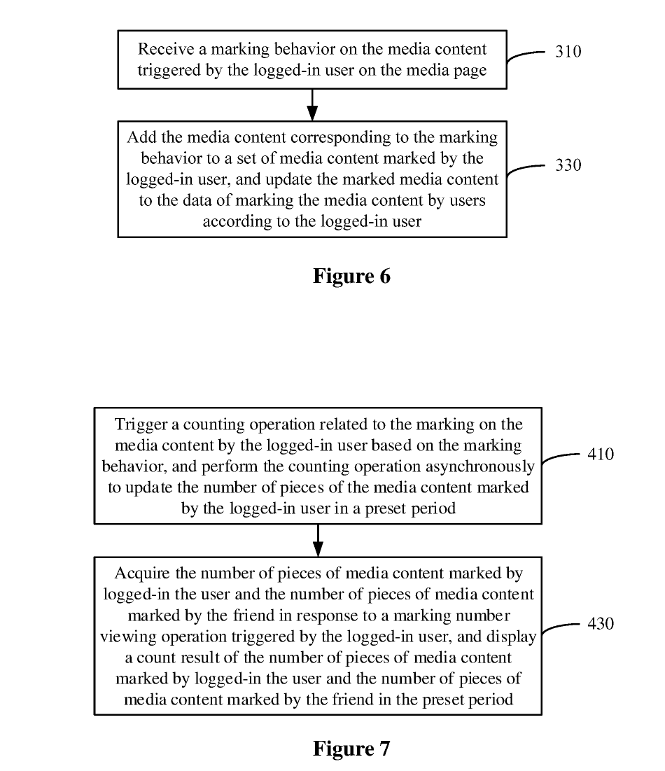

As shown in FIG. 6, in an embodiment, the method described above further includes following steps 310 to 330.

In step 310, a marking behavior on the media content triggered by the logged-in user on the media page is received.

The media page is any page including the media content, in the process of browsing the media page, the marking behavior on the media content may be triggered arbitrarily on the media page to mark the media content. For example, in a case where the user likes a few pieces of media content, i.e., music, the marking behavior may be triggered, that is, the favorite music may marked by clicking the mark triggering entry corresponding to each favorite music.

In step 330, the media content corresponding to the marking behavior is added to a set of media content marked by the logged-in user, and the marked media content is updated to the data of marking the media content by users according to the logged-in user.

The set of media content marked by the user is stored, the set of media content marked by the user records all the media content marked by the user, and all the media content marked by the user may be displayed for the user by maintaining the set of media content marked by the user, and all the media content marked by the user may be displayed as the list.

Furthermore, in the embodiment, as shown in FIG. 7, after step 310, the method described above further includes steps 410 to 430.

In step 410, a counting operation related to the marking on the media content by the logged-in user is triggered based on the marking behavior, the counting operation is performed asynchronously, to update the number of pieces of the media content marked by the logged-in user in a preset period.

Every marking behavior on the media content triggered by the logged-in user is counted, to acquire the number of pieces of the media content marked by the logged-in user in a preset period.

In order to guarantee a quick response for the marking behavior, for multiple operations for responding to the marking behavior, only a critical operation is performed synchronously. For example, the key operation includes adding the set of media content marked by the logged-in user and updating the data of marking the media content by the user. A non-critical operation is performed asynchronously.

Based on this, the counting operation for responding to the marking behavior is performed asynchronously.

With the triggering of the marking behavior, the media content marked by the logged-in user is received by a backstage server, and the number of pieces of the media content marked by the logged-in user is updated.

Furthermore, in practice, the number of pieces of the marked media content in the preset period may be acquired by counting a daily liquidity and updating the number of pieces of the marked media content in the preset period based on a result of counting the daily liquidity.

Particularly, the daily liquidity is counted in units of one day based on one or more marking behaviors triggered by the logged-in user every day, and the result of counting the daily liquidity is obtained and stored.

In mass stored results of counting the daily liquidity, corresponding results of counting the daily liquidity are selected according to the preset period to update the number of pieces of the media content marked by the user in the preset period. For example, the preset period may be 30 days.

In step 430, the number of pieces of media content marked by logged-in the user and the number of pieces of media content marked by the friend are acquired in response to a marking number viewing operation triggered by the logged-in user, and a count result of the number of pieces of media content marked by logged-in the user and the number of pieces of media content marked by the friend in the preset period is displayed.

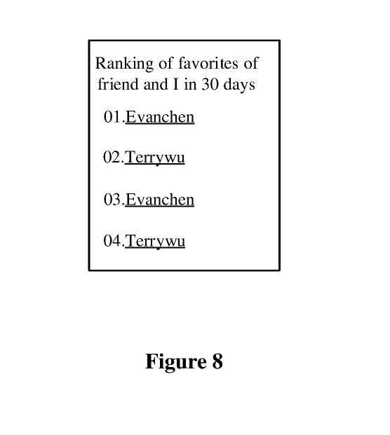

In order to enhance the interaction between the user and the friend, the number of pieces of media content marked by logged-in the user and the number of pieces of media content marked by the friend are provided in the page. The numbers may be displayed in a form of ranking, such as, the mark ranking of “friend” and “I” in 30 days, as shown in FIG. 8.

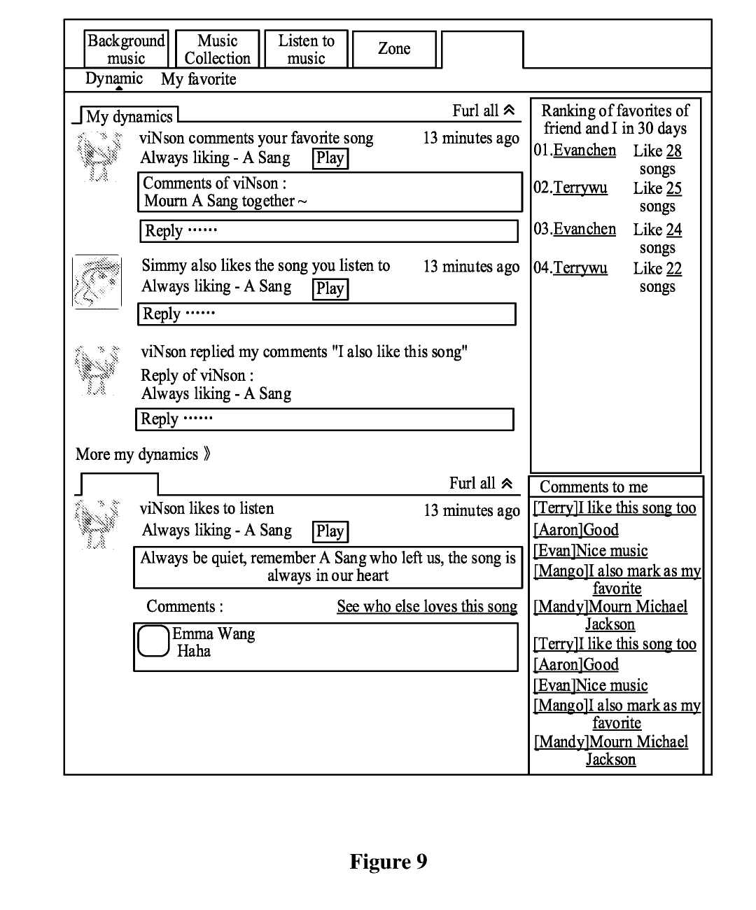

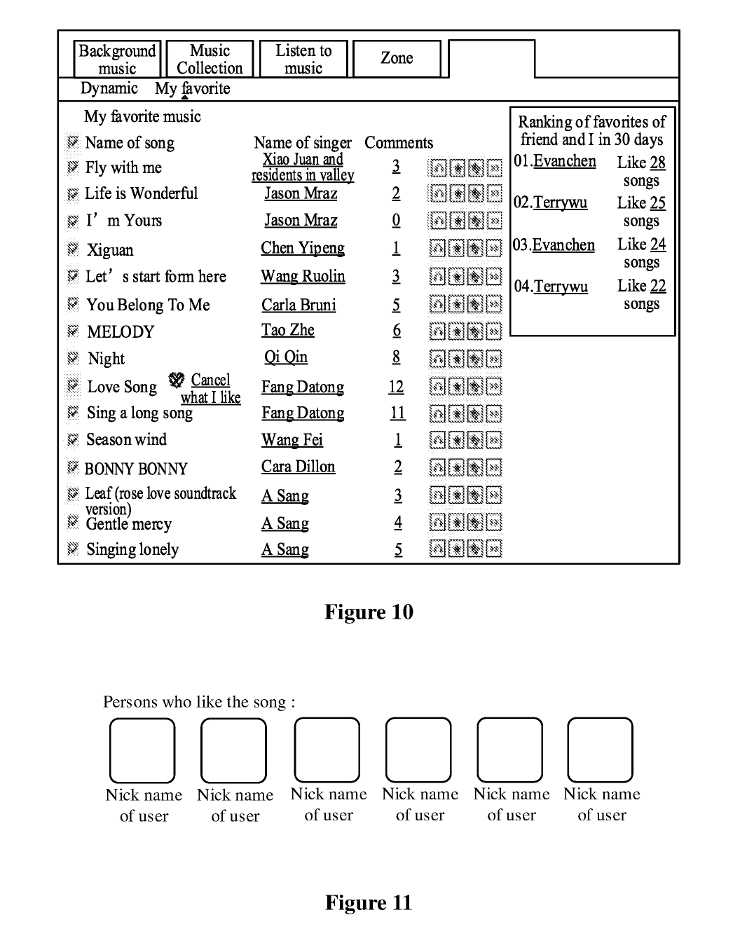

It should be noted that the number of pieces of media content marked by logged-in the user and the number of pieces of media content marked by the friend may be displayed on any page, such as, the display page for dynamic shown in FIG. 9, the page for displaying the set of the media content marked by the user in a list shown in FIG. 10. Correspondingly, the above marking number viewing operation is the acquisition operation for dynamic or a viewing operation for the display page of media content marked by the logged-in user.

Furthermore, in the present embodiment, after step 310, the method described above further includes:

triggering to count unread dynamics corresponding to the friend to obtain the number of the unread dynamics, and updating the number of the unread dynamics to a page where the friend logins.

That is, for one logged-in user, in addition to triggering the marking behavior on the media content marked by the friend, in a case where one or more marking behaviors on the media content are triggered on the media page, two dynamics are generated. One dynamic is the dynamic of marking the media content by the logged-in user, the other dynamic is the dynamic of marking the media content by the friend provide by the friend of the logged-in user.

In this case, it is triggered to count the unread dynamics corresponding to the friend to obtain an update number of the unread dynamics based on the number of pieces of media content marked by the logged-in user, and the update number is updated to the page where the friend of the logged-in user logins.

Corresponding to this, in a case where one or more pieces of media content are marked by the friend in the media page where the friend logs and the marking behavior doesn't belongs to the interaction with another friend, two dynamics are generated. One dynamic is the dynamic of marking the media content by the user corresponding to the friend, the other dynamic is the dynamic of marking the media content by the friend corresponding to the logged-in user.

In this case, a prompt for the number of the unread dynamics is performed in the page where the logged-in user is located.

Furthermore, the prompt for the number of the unread dynamics is realized by adopting a common component BitmapServer, the common component BitmapServer may make a identifier for the number of the unread dynamics be stored corresponding to the number of the unread dynamics. And the identifier for the number of the unread dynamics is stored corresponding to only one record, i.e., the number of the unread dynamics, to guarantee the high efficiency and low cost of the distributed storage.

After the stored number of the unread dynamics is obtained by reading, the page displaying the obtained number of the unread dynamics is labeled for viewing.

In an embodiment, in a case that the set of the media content marked by the logged-in user is empty, after step 310, the method further includes the step of marking the logged-in user as a user who marks the media content.

Corresponding to this, before step 130, the method further includes:

triggering to determine whether the logged-in user is the user who marks the media content in response to the acquisition operation for dynamic, executing step 130 in a caser that the logged-in user is the user who marks the media content, stopping responding to the acquisition operation for dynamic in a caser that the logged-in user is not the user who marks the media content.

Whether the user marks the media content is marked to avoid an empty query in an actual operation process, thereby reducing the burthen of the operation.

Particularly, the common component BitmapServer may be adopted to mark, the storage format of which is an one-to-one manner with a key and a value, that is, one key corresponds to only one value record, and then, whether the user marks the media content is acquired by the corresponding value.

It can be seen that every user corresponds to a value record to mark whether the user marks the media content. For example, in a process of acquiring the dynamic data of the user and the dynamic data of the friend from the data of marking the media content by users. For the dynamic data of the user, whether the user marks the media content is determined according to the value record corresponding to the user, and the dynamic data of the user is acquired in a case that the value record indicates that the user marks the media content, and the query and the acquiring for the marked value are not performed in the data of marking the media content by users in a case that the value record indicates that the user does not mark the media content. For the acquiring of the dynamic data of the friend, the procedure is similar, which is not further described here.

The empty query may be effectively avoided via the marking procedure described above, which further reduce the burthen of the operation.

In an embodiment, the method described above further includes:

acquiring a friend who marks the same media content as the user according to the friend relationship of the user based on the data of marking the media content by users, and storing the friend to provide the acquired friend for an operation of viewing the user who marks the media content triggered by the logged-in user.

That is to say, based on the media content marked by the logged-in user, for any media content, the friend who marks the same media content as the logged-in user is queried from the friends of the logged-in user according to the friend relationship based on the data of marking the media content by users, and then, the queried friend is provided for viewing the user who marks the media content triggered on the media content by the logged-in user, for example, the user having the friend relationship with each other who marks the same song as favorite, as shown in FIG. 11.

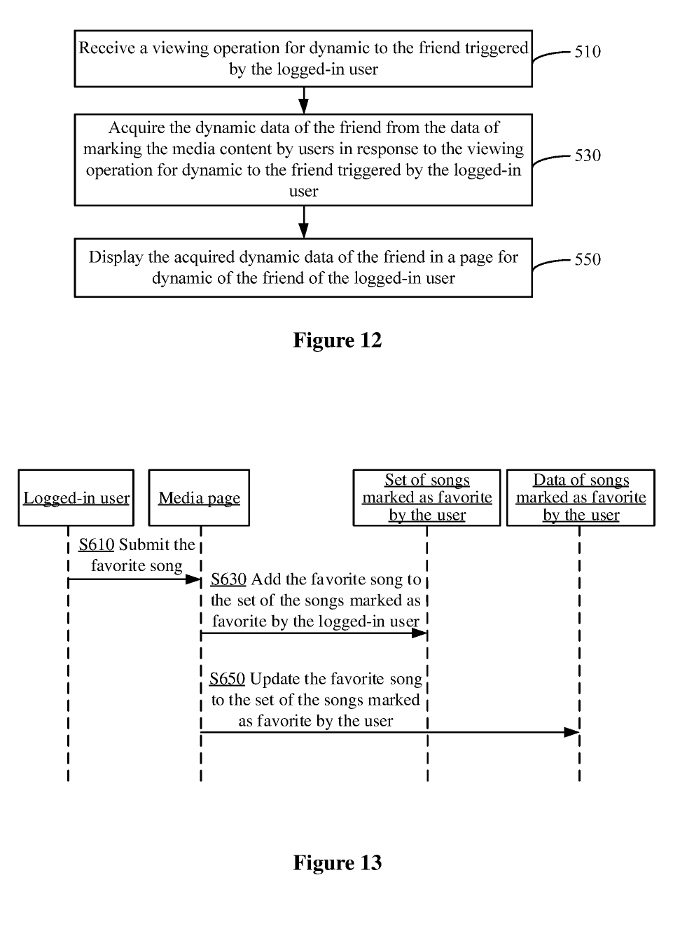

In another embodiment, as shown in FIG. 12, the method described above further includes steps 510 to 550.

In step 510, a viewing operation for dynamic to the friend triggered by the logged-in user is received.

In step 530, the dynamic data of the friend is acquired from the data of marking the media content by users in response to the viewing operation for dynamic to the friend triggered by the logged-in user.

In step 550, the acquired dynamic data of the friend is displayed in a page for dynamic of the friend of the logged-in user.

With the above steps 510 to 550, a space of a friend, i.e., the page for dynamic of the friend, may be accessed by the logged-in user, so the logged-in user may view the dynamic of marking the media content by the friend.

The procedure described above is described in detail herein after in conjunction of an embodiment. In the embodiment, the media content is a song, the performed marking the media content is illustrated by an example of marking a song as a favorite song.

The procedure of the media content-based interaction described in the present disclosure is realized by loading a variety of JS script by a browser, various operations and the marking behaviors triggered by the logged-in user are acquired and triggered to be responded by the JS script.

Particularly, in the media page including the song which is not marked as favorite by the logged-in user, a marking behavior on the song may be triggered by triggering a favorite button corresponding to the song, in this case the song is added to the set of the song marked as favorite by the logged-in user, and the data of the songs marked as favorite by the user is updated based on the song marked by the logged-in user. The detailed implementation may be refer to the time sequence procedure in FIG. 13.

Any song may be added to the favorite songs by the procedure described above. Correspondingly, for any song added to the favorite songs, the song marked as the favorite song may be removed via the button of “cancel what I like” set in the page in order to remove the song from the set of songs marked as favorite by the logged-in user and the data of the songs marked as favorite by the user.

With the procedure described above, any user may mark the song which the user likes, and the song is updated to the data of marking the media content by users, and there is friend relationship between the users, hence, the logged-in user may view the dynamic of marking the song as favorite by the user and the friend through the acquisition operation for dynamic triggered by the logged-in user.

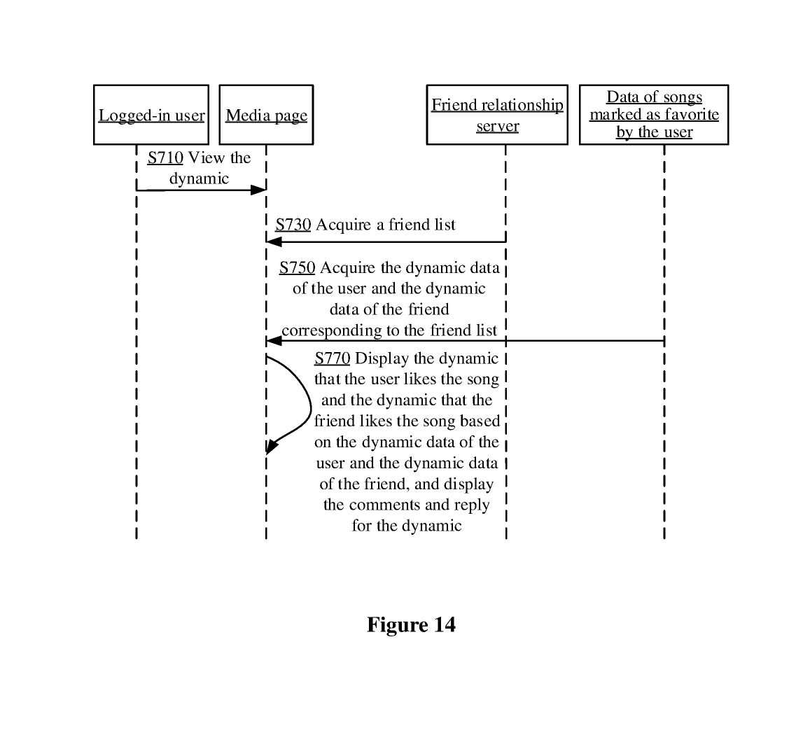

The detailed timing diagram is shown in FIG. 14, particularly, in a case where the logged-in user triggers the acquisition operation for dynamic on the media page to view the dynamic, referring to FIG. 3, the dynamic of the user and the dynamic of the friend are displayed for the logged-in user according to a generated time shaft for the dynamics, and the comments of the friend to the dynamics and the reply to the comments are displayed.

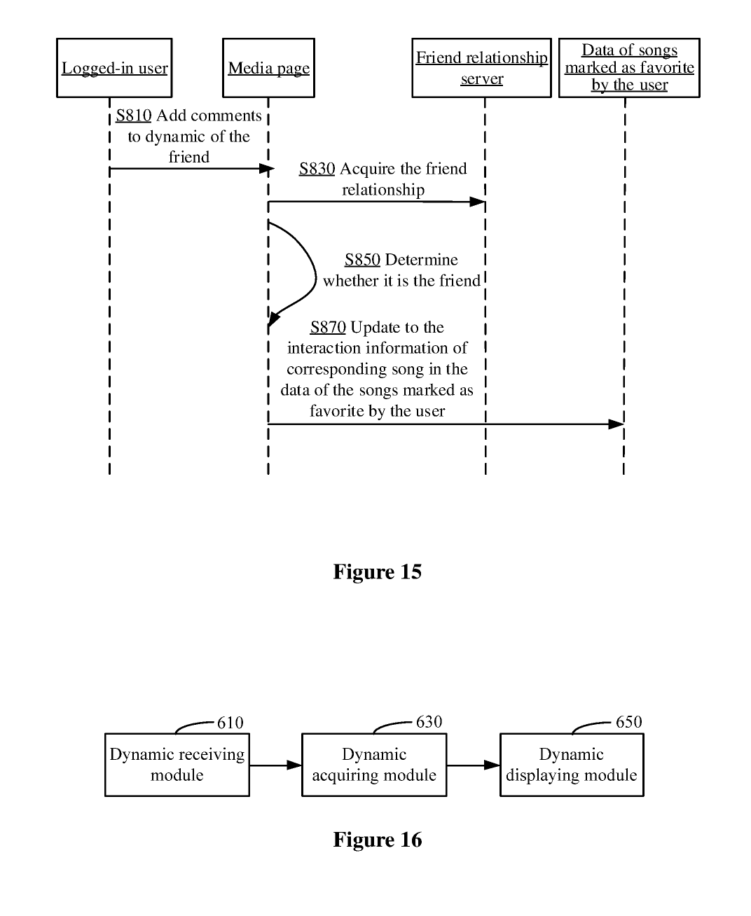

In a procedure of viewing the dynamic of the song liked by the user, the logged-in user may publish comments to any dynamic, a detailed time sequence of the comments is shown in FIG. 15. In addition, the replying to any comments may refer to the procedure, which is not repeated here.

The application situation described above lists the procedure of the response, the dynamic viewing and the interaction for the marking behavior on the media content, other functions may be implemented by referring to the implementing of the method described above.

Furthermore, as shown in FIG. 16, a system for media content-based interaction is provided, which includes a dynamic receiving module 610, a dynamic acquiring module 630 and a dynamic displaying module 650.

The dynamic receiving module 610 is configured to receive an acquisition operation for dynamic triggered by a user on a media page.

The dynamic acquiring module 630 is configured to acquire dynamic data of the user and dynamic data of a friend associated with the user in response to the acquisition operation for dynamic. The dynamic data includes marking on a piece of media content and interaction information associated with the marked media content.

The dynamic displaying module 650 is configured to display on a display page for dynamic based on the dynamic data of the user and the dynamic data of the friend.

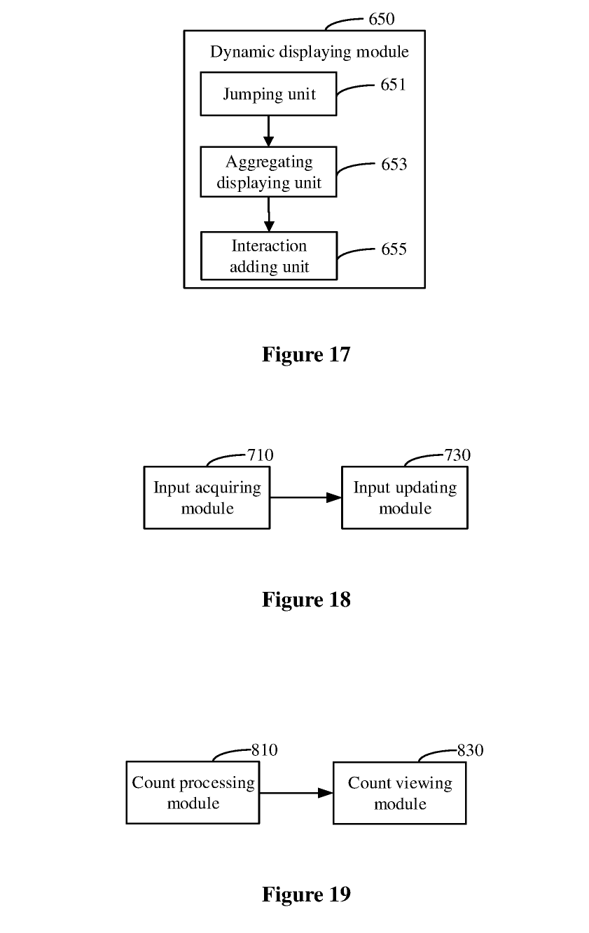

Furthermore, in the embodiment, as shown in FIG. 17, the dynamic displaying module 650 includes a jumping unit 651, an aggregating displaying unit 653 and an interaction adding unit 655.

The jumping unit 651 is configured to trigger to jump to the display page for dynamic of a logged-in user.

The aggregating displaying unit 653 is configured to aggregate the dynamics of marking the media content by the user in the dynamic data of the user and aggregate the dynamics of marking the media content by the friend in the dynamic data of the friend, and display the aggregated dynamics on the display page for dynamic.

The interaction adding unit 655 is configured to add interaction information corresponding to the dynamic to the displayed dynamic.

In an embodiment, as shown in FIG. 18, the system described above further includes an input acquiring module 710 and an input updating module 730.

The input acquiring module 710 is configured to acquire input information corresponding to the dynamic or the interaction information displayed on the display page for dynamic.

The input updating module 730 is configured to update the input information to the interaction information of the corresponding media content in the data of marking the media content by users related to the user to which the dynamic belongs.

In an embodiment, the system described above further includes an interaction acquiring module configured to acquire the interaction information from the dynamic data of the user and displaying the acquired interaction information in response to an interaction viewing operation triggered by the logged-in user.

In an embodiment, as shown in FIG. 19, the system described above further includes a count processing module 810 and a count viewing module 830.

The count processing module 810 is configured to trigger a counting operation related to the marking on the media content by the logged-in user based on the marking behavior, and perform the counting operation asynchronously to update the number of pieces of the media content marked by the logged-in user in a preset period.

The count viewing module 830 is configured to acquire the number of pieces of media content marked by logged-in the user and the number of pieces of media content marked by the friend in response to a marking number viewing operation triggered by the logged-in user, and display a count result of the number of pieces of media content marked by logged-in the user and the number of pieces of media content marked by the friend in the preset period.

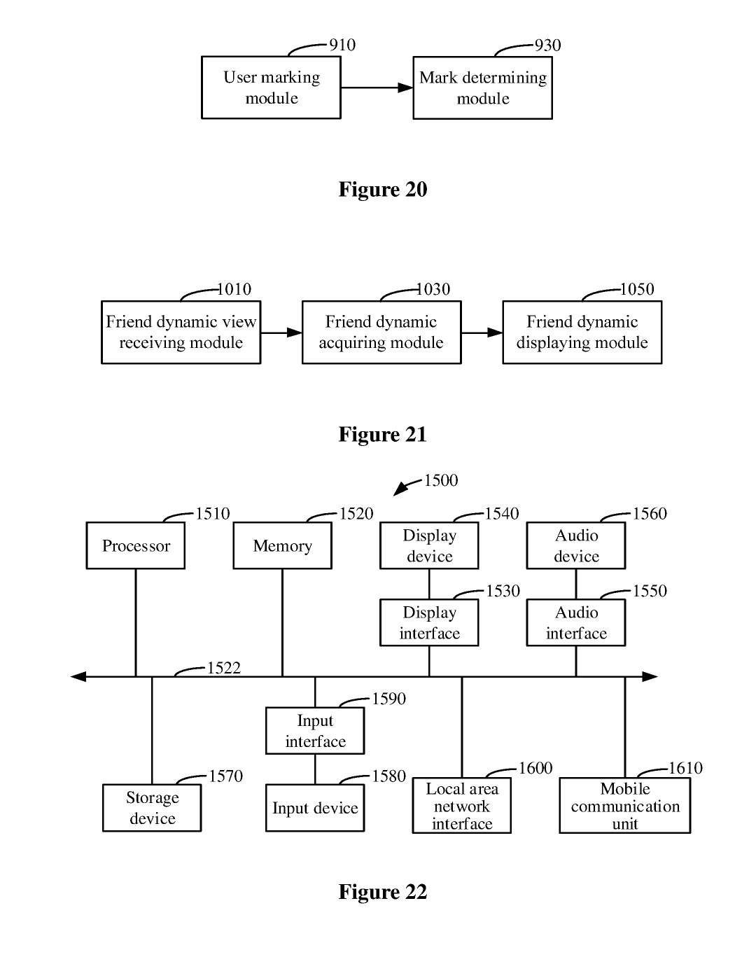

In an embodiment, as shown in FIG. 20, in a case that the set of the media content marked by the logged-in user is empty, the system described above further includes a user marking module 910 and a mark determining module 930.

The user marking module 910 is configured to mark the logged-in user as a user who marks the media content.

The mark determining module 930 is configured to trigger to determine whether the logged-in user is the user who marks the media content in response to the acquisition operation for dynamic, execute the dynamic acquiring module 630 in a caser that the logged-in user is the user who marks the media content, stop responding to the acquisition operation for dynamic in a caser that the logged-in user is not the user who marks the media content.

In an embodiment, the system described above further includes a friend acquiring module configured to acquire a friend who marks the same media content as the user according to the friend relationship of the user based on the data of marking the media content by users, and store the friend to provide the acquired friend for an operation of viewing the user who marks the media content triggered by the logged-in user.

In another embodiment, as shown in FIG. 21, the system described above further includes a friend dynamic view receiving module 1010, a friend dynamic acquiring module 1030 and a friend dynamic displaying module 1050.

The friend dynamic view receiving module 1010 is configured to receive a viewing operation for dynamic to the friend triggered by the logged-in user.

The friend dynamic acquiring module 1030 is configured to acquire the dynamic data of the friend from the data of marking the media content by users in response to the viewing operation for dynamic to the friend triggered by the logged-in user.

The friend dynamic displaying module 1050 is configured to display the acquired dynamic data of the friend in a page for dynamic of the friend of the logged-in user.

As shown in FIG. 22, FIG. 22 is a module diagram of a computer system 1500 provided in the embodiment of the present disclosure. The computer system 1500 is only an example of a computing environment suitable for the present disclosure, which is not proposed to limit the scope of the disclosure. The computer system 1500 may not be interpreted as having to depend on or include a combination of one or more components of the exemplary computer system 1500 in FIG. 22.

As shown in FIG. 22, the computer system 1500 includes a processor 1510, a memory 1520 and a system bus 1522. Various system components including the memory 1520 and the processor 1510 are connected to the system bus 1522. The processor 1510 is a hardware configured to execute computer program instructions via basic arithmetic and logical operations in the computer system. The memory 1520 is a physical device for temporarily or permanently storing computer programs or data (e.g., program state information). The system bus 1522 may be any of following types of bus architectures, including a memory bus or a memory controller, a peripheral bus and a local bus. Data communication is performed via the system bus 1522 between the processor 1510 and the memory 1520. The memory 1520 includes read only memory (ROM) or flash memory (not shown in FIG. 22), and random access memory (RAM), RAM generally refers to a main memory in which an operating system and application programs are loaded.

The computer system 1500 also includes a display interface 1530 (e.g., a graphics processing unit), a display device 1540 (e.g., a liquid crystal display), an audio interface 1550 (e.g., an audio card), and an audio device 1560 (e.g., a speaker). The display device 1540 and the audio device 1560 are media devices for experiencing multimedia content.

The computer system 1500 generally includes a storage device 1570. The storage device 1570 may be selected from a variety of computer readable medium which refer to any available medium that may be accessed through the computer system 1500, including both mobile and fixed medium. For example, computer readable medium includes, but are not limited to, flash memory (mini SD card), CD-ROM, digital versatile disk (DVD) or other optical disk storage, tape cartridges, magnetic tape, magnetic disk storage or other magnetic storage devices or any other medium that stores the desired information and can be accessed by the computer system 1500.

The computer system 1500 also includes an input device 1580 and an input interface 1590 (e.g., an TO controller). The user may input instructions and information into the computer system 1500 via the input device 1580, such as a keyboard, a mouse, a touch panel device on the display device 1540. The input device 1580 is typically connected to the system bus 1522 via the input interface 1590, but may also be connected via other interfaces or bus structures, such as a universal serial bus (USB).

The computer system 1500 may be logically connected to one or more network devices in a network environment. The network device may be a personal computer, a server, a router, a smartphone, a tablet, or other public network node. The computer system 1500 is connected to a network device via a local area network (LAN) interface 1600 or a mobile communication unit 1610. Local area network (LAN) refers to an interconnected computer network in a limited area, such as a home, a school, a computer lab, or an office building that uses network media. WiFi and twisted pair cabling Ethernet are most commonly two technology used to build LAN. WiFi is a technology that enables the computer system 1500 to exchange data or connect to a wireless network via radio waves. The mobile communication unit 1610 can answer and dial a call through the radio communication line while moving within a wide geographical area. In addition to the call, the mobile communication unit 1610 also supports Internet access in a 2G, 3G or 4G cellular communication system that provides mobile data services.

As described in detail above, the computer system 1500 suitable for the present disclosure can perform the specific operations described above for realizing the media content-based interaction. The computer system 1500 performs these operations by the processor 1510 running the software instructions in the computer readable medium. These software instructions may be read into the memory 1520 via the storage device 1570 or the LAN interface 1600 from another device. The software instructions stored in the memory 1520 cause the processor 1510 to perform the above method for media content-based interaction. In addition, the present disclosure can be implemented by hardware circuits or hardware circuits in conjunction with software instructions. Accordingly, the implementation of the disclosure is not limited to any particular combination of hardware circuits and software.

When the software instructions in the computer readable medium are executed, the processor 1510 is configured to:

receive an acquisition operation for dynamic of a user on a media page;

acquire dynamic data of the user and dynamic data of a friend associated with the user in response to the acquisition operation for dynamic, where the dynamic data includes marking on a piece of media content and interaction information associated with the marked media content; and

display on a display page for dynamic based on the dynamic data of the user and the dynamic data of the friend.

It can be understood by those skilled in the art that all or some of steps in the above embodiments may be implemented by hardware or hardware instructed by a program. The program may be stored in a computer readable storage medium, which may be a read-only memory, a magnetic disk or an optical disk.

The foregoing is merely preferred embodiments of the present disclosure which are not intended to limit the embodiments of the disclosure, those skilled in the art can conveniently adapt or modify the embodiments in accordance with the main idea and spirit of the present disclosure. The scope of protection of the disclosure should be defined based on the scope of protection required by the claims.

1. A method for media content-based interaction performed at a device for media content-based interaction comprising a processor and a memory for storing program instructions to be executed by the processor, the method comprising:
receiving an acquisition operation for dynamic of a user on a media page;
acquiring dynamic data of the user and dynamic data of a friend associated with the user in response to the acquisition operation for dynamic, wherein the dynamic data comprises marking on a piece of media content and interaction information associated with the marked media content; and
displaying the dynamic data of the user and the dynamic data of the friend on a display page for dynamic.

2. The method according to claim 1, wherein the displaying the dynamic data of the user and the dynamic data of the friend on the display page for dynamic comprises:
jumping to the display page for dynamic of the user;
displaying a piece of media content marked by the user and a piece of media content marked by the friend on the display page for dynamic; and
displaying the interaction information associated with the marked media content at a position adjacent to the marked media content.

3. The method according to claim 1, further comprising:
acquiring input information on the display page for dynamic; and
updating the input information to the dynamic data of the user or the dynamic data of the friend.

4. The method according to claim 3, further comprising:
acquiring the interaction information from the dynamic data of the user and displaying the acquired interaction information, in response to an interaction viewing operation of the user.

5. The method according to claim 1, further comprising:
receiving marking on another piece of media content by the user on the media page; and
updating the received marking to the dynamic data of the user.

6. The method according to claim 5, wherein after the receiving marking on another piece of media content by the user on the media page, the method further comprises:
counting the number of pieces of media content marked by the user and the number of pieces of media content marked by the friend and displaying a result of the counting, in response to a marking number viewing operation of the user.

7. The method according to claim 1, further comprising:
determining a friend who marks the same media content as the user based on the dynamic data of the user and the dynamic data of the friend; and
informing the determined friend to the user.

8. The method according to claim 1, further comprising:
receiving a viewing operation for dynamic to the friend of the user;
acquiring the dynamic data of the friend in response to the viewing operation for dynamic; and
displaying the acquired dynamic data of the friend on a page for dynamic of the friend.

9. The method according to claim 1, further comprising:
receiving a cancelling mark operation of the user or the friend; and
updating the dynamic data of the user or the dynamic data of the friend in response to the cancelling mark operation.

10. A device for media content-based interaction, comprising a processor and a memory for storing program instructions, wherein the processor executes the program instructions to:
receive an acquisition operation for dynamic of a user on a media page;
acquire dynamic data of the user and dynamic data of a friend associated with the user in response to the acquisition operation for dynamic, wherein the dynamic data comprises marking on a piece of media content and interaction information associated with the marked media content; and
display on a display page for dynamic based on the dynamic data of the user and the dynamic data of the friend.

11. The device according to claim 10, wherein the processor executes the program instructions further to:
jump to the display page for dynamic of the user;
display a piece of media content marked by the user and a piece of media content marked by the friend on the display page for dynamic; and
display the interaction information associated with the marked media content at a position adjacent to the marked media content.

12. The device according to claim 10, wherein the processor executes the program instructions further to:
acquire input information on the display page for dynamic; and
update the input information to the dynamic data of the user or the dynamic data of the friend.

13. The device according to claim 12, wherein the processor executes the program instructions further to:
acquire the interaction information from the dynamic data of the user and display the acquired interaction information, in response to an interaction viewing operation of the user.

14. The device according to claim 10, wherein the processor executes the program instructions further to:
receive marking on another piece of media content by the user on the media page; and
update the received marking to the dynamic data of the user.

15. The device according to claim 14, wherein the processor executes the program instructions further to:
count the number of pieces of media content marked by the user and the number of pieces of media content marked by the friend and display a result of the counting, in response to a marking number viewing operation of the user.

16. The device according to claim 10, wherein the processor executes the program instructions further to:
determine a friend who marks the same media content as the user based on the dynamic data of the user and the dynamic data of the friend and inform the determined friend to the user.

17. The device according to claim 10, wherein the processor executes the program instructions further to:
receive a viewing operation for dynamic to the friend of the user;
acquire the dynamic data of the friend in response to the viewing operation for dynamic; and
display the acquired dynamic data of the friend on a page for dynamic of the friend.

18. The device according to claim 10, wherein the processor executes the program instructions further to:
receive a cancelling mark operation of the user or the friend; and
update the dynamic data of the user or the dynamic data of the friend in response to the cancelling mark operation.

19. A non-transitory computer readable medium storing computer programs, wherein, the computer programs comprise computer instructions which cause a computer to:
receive an acquisition operation for dynamic of a user on a media page;
acquire dynamic data of the user and dynamic data of a friend associated with the user in response to the acquisition operation for dynamic, wherein the dynamic data comprises marking on a piece of media content and interaction information associated with the marked media content; and
display on a display page for dynamic based on the dynamic data of the user and the dynamic data of the friend.
